(19) United States
(12) Patent Application Publication
(10) Pub. No.: US 2004/0233662 A1
(43) Pub. Date: Nov. 25, 2004

(54) Light for matching surfaces

(76) Inventors: Achim Willing, Schesslitz-Doschendorf (DE); Gerda Willing, Schesslitz-Doschendorf (DE)

Correspondence Address: D Edward Dolgorukov, Marshall & Melhorn, 8th Floor, Four SeaGate, Toledo, OH, 43604, US

(21) Appl. No.: 10/477,965

(22) PCT Filed: May 17, 2002
(86) PCT No.: PCT/EP02/05509

(30) Foreign Application Priority Data
May 18, 2001 (DE) 101 25 751.1

(51) Int. Cl. F21S 4/00

(52) U.S. Cl. 362/219

(57) ABSTRACT

A luminaire is proposed for matching surfaces which has a light source arrangement accommodated in a housing, a light exit surface provided in the housing and delimiting surfaces delimiting the light emission of the light source arrangement, to form at least one light channel between the light source arrangement and the light exit surface.

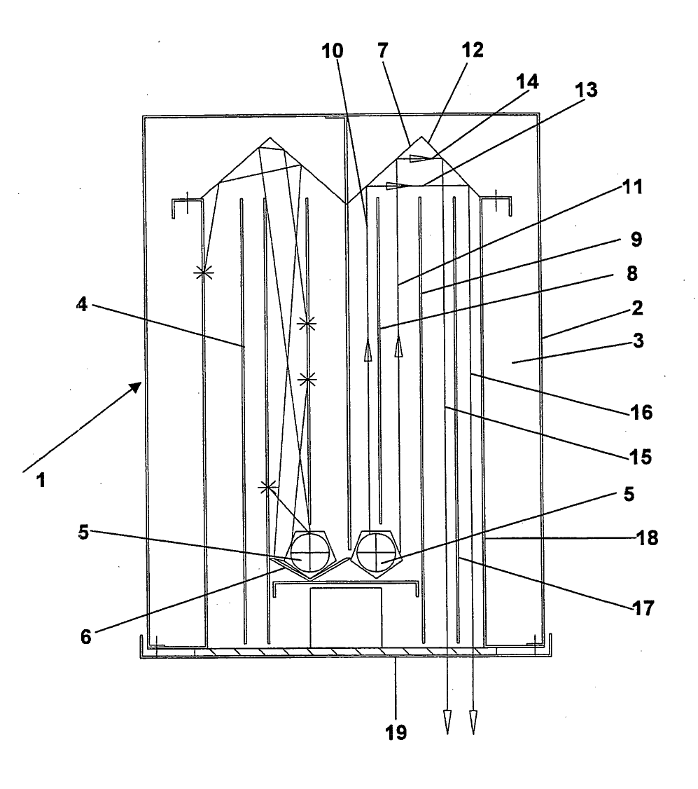

The at least one light channel is deflected by at least one radiation deflecting device at an angle of greater 90°, in such a way that light channel sections are formed, the length of the light channel sections, when viewed in the direction of radiation, being many times greater than their width with respect to the direction of radiation.

The invention relates to a luminaire for matching surfaces in accordance with the preamble of the main claim.

Luminaires for matching are known for inspecting surfaces to recognise surface faults, which luminaires have areas emitting light in stripes or in a pattern and by means of which the surfaces are illuminated. By altering the stripes or pattern as a result of faults on the surface, these faults can be recognised. Furthermore, the luminaires for matching must have tight focussing of the radiation or respectively the light emission must be limited to the solid angle required to illuminate the surfaces, in order to avoid dazzle when viewing the light-emitting surface directly.

From WO 01/16584 is known for example a luminaire arrangement which has an elongate light source with a reflector or a plurality of elongate light sources, lamellae being arranged in front of the light source which guide or lead the emitted light in a plurality of light channels lying beside one another. The lamellae have a relatively large length in planes parallel to the longitudinal axis of the elongate light sources, by which means a luminaire for matching which is designed with these lamellae has a large constructional height or depth, such that luminaires of this type require a good deal of space.

The object underlying the invention, therefore, is to create a luminaire for matching surfaces, which has a relatively small constructional height and which emits light in stripes or in a pattern in a tightly focussed manner in at least one plane of radiation.

This object is accomplished according to the invention by the features of the main claim.

The luminaire for matching surfaces has a light source arrangement accommodated in a housing, as well as a light exit surface provided in an aperture of the housing and delimiting surfaces, which delimit the light emission from the light source and which form at least one light channel between the light source arrangement and the light exit surface, the light channel being deflected by a deflecting device, forming light channel sections, at an angle of >90°, the length of the light channel sections, when viewed in the direction of radiation, being many times greater than their width transversely with respect to the direction of radiation. Due to the deflection of the at least one light channel, it being possible also for a plurality of light channels to be provided, arranged beside one another, the lengths of the light channels required for light focussing can be extended without increasing the constructional depth of the light. If necessary, the light channel can also be deflected several times.

The deflection takes place according to the invention using known optical means such as reflectors, e.g. a plurality of planar reflectors having as high as possible specular reflectivity and which are disposed at an angle to one another, deviating prisms or curved light guide arrangements.

By preference, the deflection takes place at an angle of 180°, such that a plurality of light channel sections are arranged parallel to one another. The cross-section of the light channels is so configured that the desired light distribution and the desired pattern of the light exit surfaces is produced. Thus the cross-section can be designed rectangular in order to achieve lamellar light distribution, or the light channels can comprise round or square tubes in order to obtain focussing of the light emission in all directions.

The delimiting surfaces of the light channels are preferably designed light-absorbent, and are especially black.

In order to obtain balanced transitions of the light distribution of light channels lying beside one another, it is particularly propitious to select an absorbent material which has a high degree of specular reflectivity with very flat light entry angles.

The light channels can be filled with air or however with transparent solid or liquid material, on the outer side of which the absorbent delimiting surfaces are attached in an optically tight manner.

The light source arrangement is preferably configured as an elongate tubular light source; however substantially point-type lamps can also be used which are arranged for example in a row and which are provided with parabolic mirrors for focussing, or in a grooved mirror which only focuses in one direction. So-called “aperture lamps” can also be used in which light is emitted from a strip-shaped light window with increased luminance. Fluorescent lamps are also suitable as aperture lamps.

A plurality of light tubes can be provided with corresponding light channels in one luminaire; also a plurality of lamps can be provided for each light channel.

For distinguishing better from extraneous light, the light sources can also emit coloured light, e.g. red light. An embodiment of the invention is illustrated in the drawing and is described in greater detail in the following description.

The single FIGURE shows a schematic sectional view through the luminaire.

The luminaire 1 illustrated in the figures has a housing 2, in which two luminaire modules 3, 4 are accommodated, which are arranged mirrored on one another. Each luminaire module 3, 4 has an elongate light source 5, for example a fluorescent lamp, the light radiation of which can be amplified in the direction of the light channel by mirror coatings, the housing or reflectors 6. In front of and beside the light source 5, plate-shaped lamellae 7, 8, 9 are disposed in this embodiment, by means of which the emitted light can be guided in a channelled manner. In the embodiment, two light channel sections 10 and 11 are formed by the lamellae 7 to 9, the length of the light channel sections 10, 11 being very much greater than their width, i.e. the spacing between the lamellae 7 and 8 or respectively 8 and 9 is very much greater, and the height of these channel sections corresponds roughly to the length of the elongate light source 5′.

At the end of the light channel sections 10, 11 is arranged a reflector which in the embodiment is configured V-shaped with an angle of 90°, by means of which the radiation emitted by the light source 5 and channelled by the light channel sections 10, 11 is deflected according to arrows 13, 14 twice by 90°, and is guided in further light channel sections 15, 16, which are formed by additionally provided lamellae or respectively plate-shaped walls 17, 18. The luminaire 1 has a light exit aperture covered for example with a cover disc 19, through which aperture the radiation emerges with a substantially lamellar light distribution according to the arrows shown.

Additional reflectors 12 can be provided as deflecting devices, the light channel sections then being disposed beside one another in a meander pattern.

Furthermore, the reflector 12 illustrated is provided as the deflecting device with an angle of 90°, i.e. it deflects by 180°; naturally other shapes and angles can also be selected here, in this case however the luminaire is enlarged in its width since the light channel sections do not then lie parallel beside one another.

In this embodiment two light sources 5 are illustrated, the light source or respectively the light source arrangement can have one, two or more lamps; instead of tubular lamps substantially point-type lamps can also be used which are preferably arranged beside one another and which are provided with parabolic mirrors for focussing, or which are arranged in a grooved mirror which only focuses in one direction.

In this embodiment the lamellae 7, 8, 9 and 17, 18 are configured plate-like and are provided in planes parallel to the lamp axis; however transverse lamellae are also possible such that a grid or pattern is emitted and the light channel sections are configured tubular.

It is also conceivable for tubes to be used as light channel sections, which are arranged parallel beside one another to form a tube bundle.

In the embodiment shown, two modules are illustrated; a plurality of modules can also be arranged beside one another.

As can be seen from the drawing, in the region of the light source 5 a so-called dead zone is produced through which no light can be emitted through the light exit aperture 19. This zone can be incorporated into a desired light pattern; however it cannot be totally avoided in the present example.

In the drawing is shown on the left-hand side how the light emission of the luminaire is narrowed at the delimiting surfaces of the light channels by absorption of the light emitted by the lamp in undesired directions.

In order to achieve greater efficiency of the luminaires, a reflector 6 is shown by way of example which focuses the light of the lamp 5.

A luminaire as shown in the drawing is suitable both for matching surfaces of building shells at a flat angle and for glossy and lacquered surfaces at steeper angles.

1-19. (Canceled)

20. A luminaire for matching surfaces, which has a light source arrangement accommodated in a housing, a light exit surface provided in the housing and delimiting surfaces delimiting the light emission of the light source arrangement, to form at least one light channel between the light source arrangement and light exit surface, wherein the at least one light channel is deflected by at least one radiation deflecting device at an angle of >90°, in such a way that light channel sections are formed, the length of the light channel sections, when viewed in the direction of radiation, being many times greater than their width with respect to the direction of radiation.

21. The luminaire according to claim 20, wherein a plurality of light channels are arranged beside one another.

22. The luminaire according to claim 20, wherein the at least one radiation deflecting device is configured as a reflector, which deflects the radiation guided in the respective light channel section between the light source arrangement and reflector, by an angle >90° in the respective deflected light channel section.

23. The luminaire according to claim 22, wherein the reflector deflects the radiation by substantially 180° and in that the light channel sections lie parallel to one another.

24. The luminaire according to claim 20, wherein a plurality of radiation deflecting devices are provided, which deflect the at least one light channel repeatedly to form a plurality of light channel sections lying behind one another in the direction of radiation.

25. The luminaire according to claim 24, wherein the light channel sections of the light channel are arranged in a meander pattern.

26. The luminaire according to claim 20, wherein the delimiting surfaces of the at least one light channel and/or of the light channel sections are configured as lamellae or plates which are arranged parallel in the direction of radiation.

27. The luminaire according to claim 20, wherein the light source arrangement includes at least one elongate light source.

28. The luminaire according to claim 27, wherein a reflector is associated with the elongate light source.

29. The luminaire according to claim 27, wherein the elongate light source is at least one tubular lamp.

30. The luminaire according to claim 28, wherein the elongate light source is at least one tubular lamp.

31. The luminaire according to claim 20, wherein the light source arrangement is a plurality of substantially point-type lamps.

32. The luminaire according to claim 31, wherein one or more mirrors or reflectors are associated with the lamps.

33. The luminaire according to claim 26, wherein the lamellae or plates are arranged in planes parallel to the longitudinal direction of the elongate light source, to form at least one substantially lamellar light channel and/or lamellar light channel sections.

34. The luminaire according to claim 26, wherein the lamellae or plates are arranged in planes parallel and transversely with respect to the longitudinal direction of the elongate light source, to form tubular light channels and/or light channel sections.

35. The luminaire according to claim 20, wherein the delimiting surfaces of the at least one light channel and/or of the light channel sections are configured as tubes arranged in the direction of radiation.

36. The luminaire according to claim 20, wherein the delimiting surfaces are configured light-absorbent.

37. The luminaire according to claim 20, wherein the deflection device comprises a reflector arrangement formed from high-gloss material.

38. The luminaire according to claim 20, wherein the deflection device comprises prisms.

39. The luminaire according to claim 20, wherein the deflection device comprises a light guide arrangement.
